(19) United States
(12) Patent Application Publication
(10) Pub. No.: US 2014/0247260 A1
(43) Pub. Date: Sep. 4, 2014

(54) Biomechanics Sequential Analyzer

(71) Applicant: Indiana University Research & Technology Corporation, Indianapolis, IN (US)

(72) Inventors: Ahmed Ghoneima, Fishers, IN (US); Ahmed Abdel Hamid Kaboudan, Cairo (EG); Sameh Talaat, Cairo (EG)

(73) Assignee: Indiana University Research & Technology Corporation, Indianapolis, IN (US)

(21) Appl. No.: 14/193,712

(22) Filed: Feb. 28, 2014

Related U.S. Application Data
(60) Provisional application No. 61/771,328, filed on Mar. 1, 2013.
(60) Provisional application No. 61/815,361, filed on Apr. 24, 2013.

(51) Int. Cl. G06T 17/00

(52) U.S. Cl. CPC G06T 17/00
USPC 345/419

(57) ABSTRACT

A method for generating a graphical output depicting three-dimensional models includes generating first and second orientation triangles with reference to locations on a first element of first and second three-dimensional (3D) models of an object, respectively. The method further includes generating a graphical display of the oriented second 3D model superimposed on the first 3D model with a display device, the graphical display depicting a change in position of the first element between the first 3D model and the second 3D model with reference to the first orientation triangle and the second orientation triangle.

### CLAIM OF PRIORITY

This application claims priority to U.S. Provisional Application No. 61/771,328, which is entitled “Biomechanics Sequential Analyzer” and was filed on Mar. 1, 2013, the entire contents of which are incorporated by reference herein. This application claims further priority to U.S. Provisional Application No. 61/815,361, which is entitled “Biomechanics Sequential Analyzer,” and was filed on Apr. 24, 2013, the entire contents of which are incorporated by reference herein.

### TECHNICAL FIELD

This disclosure is related to systems and methods for visualization of three-dimensional models of physical objects and, more particularly, to systems and methods for visualization of biomechanical movement in medical imaging.

### BACKGROUND

In many fields, including medical imaging, the generation of three-dimensional models corresponding to physical objects for display using computer graphics systems enables analysis that is impractical to perform using a direct examination of the object. For example, some orthodontic treatments perform a gradual adjustment of teeth in the mouth of a patient. The adjustment often takes weeks or months to perform, and the teeth move gradually over the course of treatment. The movement of the teeth during the orthodontic treatment is one example of biomechanics, which further includes the analysis of movement in an organism such as a human.

In orthodontia, the teeth move relatively short distances over a protracted course of treatment. Consequently, the biomechanics of tooth movement cannot be observed directly as the teeth move. Instead, images or castings of the mouth are generated during treatment sessions to observe changes in the positions of teeth over time during the orthodontic treatment. Traditional imaging techniques, such as cephalometric radiographs, which use X-rays, depict two-dimensional images of the teeth in the mouth, and cone beam computed tomography (CBCT) generates three-dimensional models of the teeth in the mouth. The traditional imaging techniques, however, require expensive equipment and expose the patient to X-ray radiation during the imaging process.

Another imaging technique uses three-dimensional laser scanners to generate model of the interior of the mouth for the patient during the orthodontic treatment. The laser scanners are less expensive than traditional X-ray or computed tomography equipment and do not expose the patient to X-ray radiation. One challenge with the use of laser scanned models is that the scanned model forms a three-dimensional “point cloud” instead of a traditional X-ray image or series of X-ray images that form a tomographic model. In some configurations, the laser light from a laser scanner is applied to castings of the mouth and teeth in the patient, and the scanning process does not include direct exposure of the patient to the laser light. In an in-situ scanning process, the laser scanner shines the laser on the interior of the mouth, but the laser light does not penetrate the tissue of a patient in the same manner as an X-ray. In either configuration, the point cloud data from the laser scanner only includes measurements of the surfaces of the mouth and teeth. Another challenge is that teeth often move both linearly and rotationally during orthodontic treatment, and existing imaging systems do not clearly depict complex tooth movement in an easily assessable manner by a doctor or other healthcare professional. Consequently, improved methods and systems for three-dimensional imaging for the display of three-dimensional models and movements of elements within the three-dimensional models would be beneficial.

### SUMMARY

In one embodiment, a method for generating a graphical output depicting three-dimensional models includes generating a first orientation triangle with a processor with reference to a first plurality of locations on a first element of a first three-dimensional (3D) model of an object stored in a memory, the first element occupying a first position in the first 3D model and a second position in a second 3D model of the object stored in the memory, generating a second orientation triangle for the first element from a second plurality of locations on the first element in the second 3D model of the object with the processor, and generating a graphical display of the oriented second 3D model superimposed on the first 3D model with a display device, the graphical display depicting a change in position of the first element between the first 3D model and the second 3D model with reference to the first orientation triangle and the second orientation triangle.

In another embodiment, system that generates a graphical output depicting three-dimensional models has been developed. The system includes a memory configured to store first three-dimensional (3D) model data of an object including a first element and a second element, the first element being in a first position relative to the second element, second 3D model data of the object including the first element in a second position relative to the second element, a display device, and a processor operatively connected to the memory and the display device. The processor is configured to generate a first orientation triangle with reference to a first plurality of locations on the first element in the first 3D model, generate a second orientation triangle with reference to a second plurality of locations on the first element in the second 3D model, and generate with the display device a graphical display of the second 3D model superimposed on the first 3D model, the graphical display depicting a change in position of the first element between the first 3D model and the second 3D model with reference to the first orientation triangle and the second orientation triangle.

### BRIEF DESCRIPTION OF THE DRAWINGS

FIG. 1 is a schematic diagram of a system that generates scanned three-dimensional (3D) model data corresponding to elements in a mouth for identification of rotational and translational movement of elements in the mouth, such as the movement of teeth, in three dimensions.

FIG. 2 is a block diagram of a process for comparison of two 3D models that correspond to a mouth generated at different times during orthodontic treatment to identify the translation and rotational movement of one or more teeth in the mouth during treatment.

FIG. 3 is a block diagram of a process for orienting two 3D models corresponding to a mouth during the process of FIG. 2.

FIG. 4 is a block diagram of a process for selecting landmark features on teeth during the process of FIG. 2.

FIG. 5 is a block diagram of a process for generating orientation triangles corresponding to selected landmarks on a tooth in a 3D model during the process of FIG. 2.

FIG. 6 is a block diagram of a process for aligning a graphical avatar to a 3D model of a tooth in an optional embodiment of the process of FIG. 2.

FIG. 7 is a block diagram of a process for selecting superimposition registration locations in the first 3D model and the second 3D model in the process of FIG. 2.

FIG. 8 is a block diagram of a process for identifying left and right registration locations on a static element in a 3D model, such as the palate in a 3D model of a mouth, in the process of FIG. 2.

FIG. 9 is a block diagram of a process for superimposing a second 3D model on a first 3D model during the process of FIG. 2.

FIG. 10 is a block diagram of a process for identifying rotational and translational movement of a tooth with reference to the superimposed first 3D model and second 3D model during the processing of FIG. 2.

### DETAILED DESCRIPTION

For a general understanding of the environment for the system and method disclosed herein as well as the details for the system and method, reference is made to the drawings. In the drawings, like reference numerals have been used throughout to designate like elements.

As used herein, the term “object” refers to any physical item that is suitable for scanning and imaging with, for example, a laser scanner. In a In a medical context, examples of objects include, but are not limited to, portions of the body of a human or animal, or models that correspond to the body of the human or animal. For example, in dentistry objects include the interior of a mouth of the patient, a negative dental impression formed in compliance with the interior of the mouth, and a dental cast formed from the dental impression corresponding to a positive model of the interior of the mouth. As used herein, the term “element” refers to a portion of the object, and an object comprises one or more elements. In an object, at least one element is referred to as a “static” or “reference” element that remains in a fixed location relative to other elements in the object. Another type of element is a “dynamic” element that may move over time in relation to other elements in the object. In the context of a mouth or dental casting of a mouth, the palate (roof of the mouth) is an example of a static element, and the teeth are examples of dynamic elements.

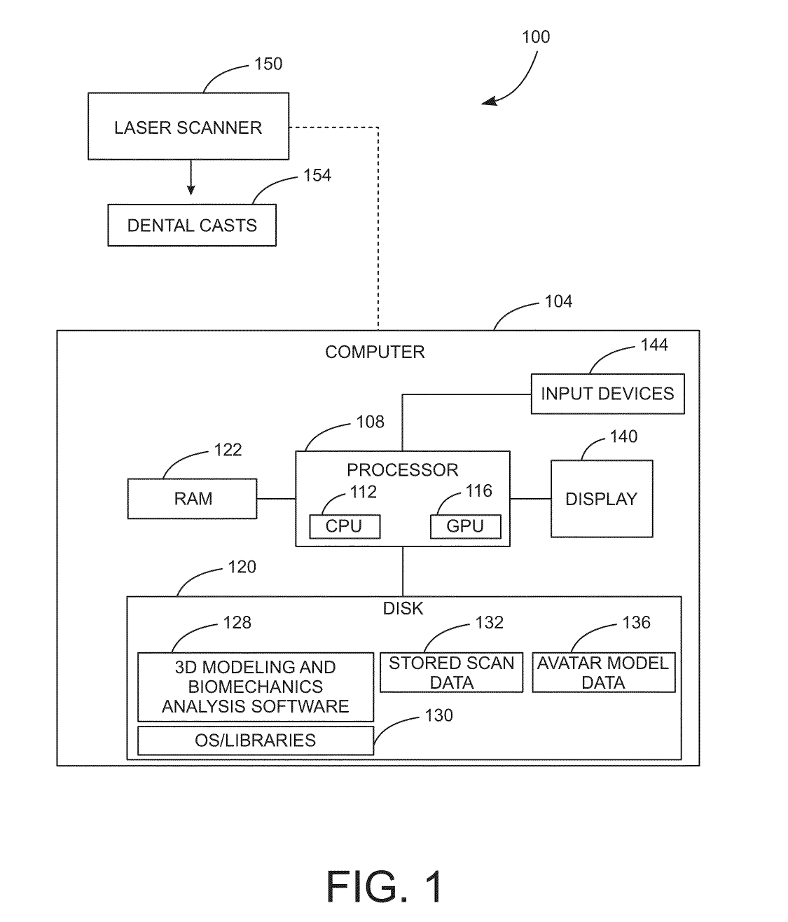

FIG. 1 depicts a system 100 for generating graphical depictions of three-dimensional (3D) models of an object including multiple models for the object that are generated at different times to depict movement of dynamic elements in the object over time. In the illustrative embodiment of FIG. 1, the system 100 is configured to generate graphical depictions of 3D models corresponding to the mouth and teeth of a patient to depict the movement of teeth over time during orthodontic treatment. In the system 100, the computer is configured to receive scan data from the laser scanner 150 using, for example, a universal serial bus (USB) connection, wired or wireless data network connection, removable data storage device such as a disk or removable solid-state memory storage card, or any other suitable communication channel.

The system 100 includes a computer 104 and a laser scanner 150 that is configured to generate three-dimensional scan data of multiple dental casts 154. The dental casts 154 are formed at different times during treatment of a patient to produce a record of the movements of teeth over time in response to various orthodontic treatments. The dental casts 154 are formed using techniques that are known to the art. The laser scanner 150 is a commercially available laser scanner that generates a three-dimensional point cloud of scanned data corresponding to multiple points on the surface of the dental casts 154 including both static and dynamic elements, such as a portion of the dental cast corresponding to the roof of the mouth and teeth, respectively. While FIG. 1 depicts a configuration that scans dental casts, alternative embodiments generate three-dimensional scan data of dental impressions or in-situ scanned data directly from the mouth of the patient.

In the system 100, the computer 104 includes a processor 108, random access memory (RAM) 122, a non-volatile data storage device (disk) 120, an output display device 140, and one or more input devices 144. The processor 108 includes a central processing unit (CPU) 112 and a graphical processing unit (GPU) 116. The CPU 112 is, for example, a general-purpose processor from the x86, ARM, MIPS, or PowerPC families. The GPU 116 includes digital processing hardware that is configured to generate rasterized images of 3D models through the display device 140. The GPU 116 includes graphics processing hardware such as programmable shaders and rasterizers that generate 2D representations of a 3D model in conjunction with, for example, the OpenGL and Direct 3D software graphics application programming interfaces (APIs). In one embodiment, the CPU 112, GPU 116, and associated digital logic are formed on a System on a Chip (SoC) device. In another embodiment, the CPU 112 and GPU 116 are discrete components that communicate using an input-output (I/O) interface such as a PCI express data bus. Different embodiments of the computer 104 include desktop and notebook personal computers (PCs), smartphones, tablets, and any other computing device that is configured to generate 3D models of the scanned data from the laser scanner 150 and identify the changes in location for dynamic elements, such as teeth, between different sets of scanned data for an object.

The processor 108 is operatively connected to the disk 120 to store and retrieve digital data from the disk 120 during operation. The disk 120 is, for example, a solid-state data storage device, magnetic disk, optical disk, or any other suitable device that stores digital data for storage and retrieval by the processor 108. The disk 120 is non-volatile data storage device that retains stored data in the absence of electrical power. While the disk 120 is depicted in the computer 104, some or all of the data stored in the disk 120 is optionally stored in one or more data storage devices that are operatively connected to the computer 104 through a data network such as a local area network (LAN) or wide area network (WAN). Other embodiments of the disk 120 include removable storage media such as removable optical disks and removable solid-state data storage cards and drives that are connected to the computer 104 using, for example, a universal serial bus (USB) connection. In the configuration of the computer 104, the disk 120 stores programmed instructions for a 3D modeling and biomechanics software application 128. The software program 128 operates in conjunction with an underlying operating system (OS) and software libraries 130 including, for example, the Microsoft Windows, Apple OS X, or Linux operating systems and associated graphical libraries and services. As described in more detail below, the 3D modeling and biomechanics software application enables an operator to view 3D models that are generated from multiple sets of scanned data from the laser scanner 150 to enable generation of multiple 3D models corresponding to different dental castings 154. The software 128 measures the movements of one or more teeth over time corresponding to changes in the relative locations of the teeth in the castings 154.

The disk 120 also stores scanned data 132 that the computer 104 receives from the laser scanner 150. The stored scanned data 132 include one or more sets of point cloud coordinates corresponding to the dental casts 154. In one configuration, the disk 120 stores the scanned image data for different dental casts 154 over a prolonged course of treatment for a patient to maintain a record of the location of teeth in the mouth of the patient over the course of orthodontic treatment. The 3D modeling and biomechanics software application 128 processes the scanned data 132 for two or more dental castings to measure the changes in location of teeth over time during the orthodontic treatment.

In addition to the scanned data, the disk 120 stores graphical avatar data 136. The avatar data 136 include polygon models and other three-dimensional graphics data corresponding to one or more elements in the mouth such as, for example, the roof of the mouth and the teeth. The graphical avatar for a tooth includes the portions of the tooth that are typically visible in the mouth, such as the enamel and the crown of the tooth, and the portions of the tooth that extend into the gums such as the root. As described below, the graphical avatars are used to generate a graphical model of the mouth corresponding to the scanned image data. Since the scanned data correspond to only portions of the mouth or the dental impressions and casts that reflect laser light to the laser scanner 150, the graphical avatars provide a visual representation of the mouth and teeth in the mouth for a graphical output. The graphics data for the avatars optionally include generic models for the individual teeth that are scaled, translated, and rotated in a 3D space to form the model. Thus, the graphical avatars are not necessarily accurate graphical representations of the exact shape of the teeth in the mouth, but are instead representative of generic human teeth that provide a model to identify the movement of one or more teeth in the mouth of the patient.

The RAM 122 includes one or more volatile data storage devices including static and dynamic RAM devices. The processor 108 is operatively connected to the RAM 122 to enable storage and retrieval of digital data. In one embodiment, the CPU 112 and the GPU 116 are each connected to separate RAM devices, while in another embodiment both the CPU 112 and GPU 116 in the processor 108 are operatively connected to a unified RAM device. During operation, the processor 108 and data processing devices in the computer 104 store and retrieve data from the RAM 122. As used herein, both the RAM 122 and the disk 120 are referred to as a “memory” and program data, scanned sensor data, graphics data, and any other data processed in the computer 104 are stored in either or both of the disk 120 and RAM 122 during operation.

The display 140 is a display device that is operatively connected to the GPU 116 in the processor 108 and is configured to display 3D graphics of the object and elements in the object, including graphics that depict movement of one or more dynamic elements in the object. In one embodiment, the display 140 is an LCD panel or other flat panel display device that is integrated into a housing of the computer 104 or connected to the computer 104 through a wired or wireless display connection. In another embodiment, the display device 140 includes a 3D display that generates a stereoscopic view of 3D object models and the 3D environment to provide an illusion of depth in a 3D image, or a volumetric 3D display that generates the image in a 3D space.

The input devices 144 include any device that enables an operator to manipulate the size, position, and orientation of a graphical depiction of a 3D model in a 3D virtual space and to select feature locations on both the static and dynamic elements of the 3D model. For example, a mouse, touchpad, or trackball are used in conjunction with a keyboard enable the operator to pan, tilt, and zoom a 3D model corresponding to the mouth to view the model from different perspectives. The operator manipulates a cursor to select locations on the roof of the mouth, which is a static element in the model, and to select locations on the teeth, which are dynamic elements. In another embodiment, the input device 144 is a touchscreen input device such as a capacitive or resistive touchscreen that is integrated with the display device 140. Using the touchscreen interface, the operator uses fingers or a stylus to select the locations on the static and dynamic elements of the mouth. Still other input devices include three-dimensional depth-cameras and other input devices that capture hand movements and other gestures from the operator to manipulate the 3D model and to select locations on the static and dynamic elements of the model of the object.

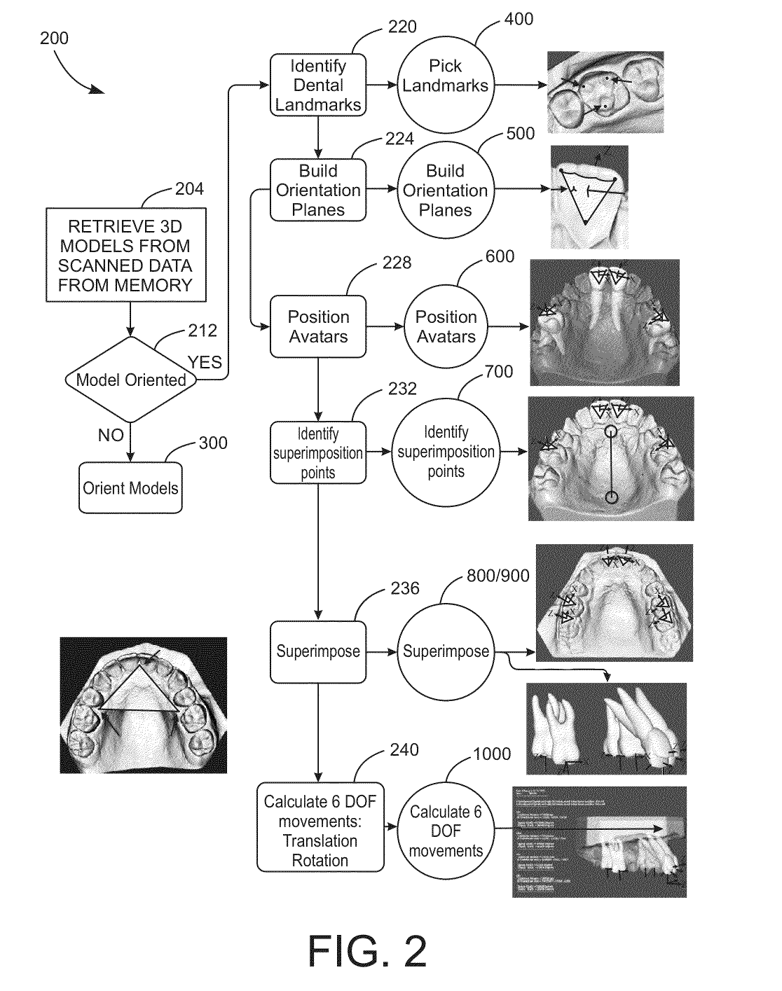

FIG. 2 depicts a process 200 for the generation of 3D models corresponding to an object that depict changes in the position of a dynamic element in the object over time. In the example of FIG. 2, the object is a mouth and the process 200 generates displays of 3D models that show the movement of teeth in the mouth during a course of orthodontic treatment. In the description below, a reference to the process 200 performing an action or function refers to a processor, such as the processor 108 in the computer 104, executing stored program instructions in conjunction with one or more hardware components in the computer to perform the action or function.

The process 200 begins with retrieval of the scanned data corresponding to two different 3D models of the mouth including at least one static element in the mouth, such as the roof of the mouth, and dynamic elements, such as the teeth (block 204). In the system 100, the processor 108 retrieves stored scanned data 128 from the disk 124 for the sensor data generated from different sets of dental casts 154. In the illustrative embodiment of process 200, the process 108 retrieves scanned data corresponding to two different models of the mouth that are generated at different times during the course of orthodontic treatment. In another embodiment, the data from a series of models taken over the course of orthodontic treatment are retrieved.

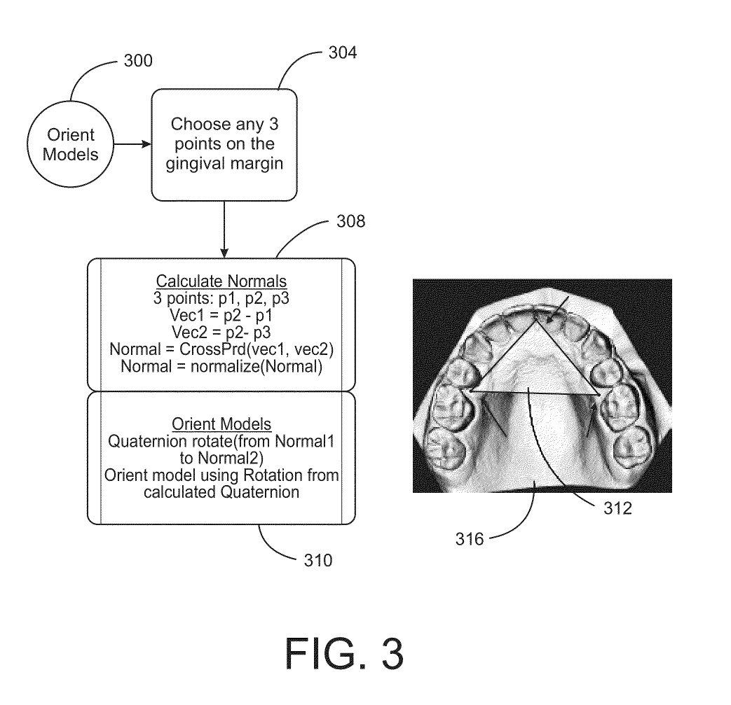

Process 200 continues with identification of whether the 3D models are oriented to a common set of axes in a 3D space (block 212). If the models are not oriented, then the processor 108 orients both of the 3D models in the 3D space. FIG. 3 depicts the orientation process 300 in more detail. In FIG. 3, the computer 104 accepts input from an operator through the input devices 144 to select three locations on the gingival margin of the roof of the mouth forming a triangle, such as the triangle 312 depicted on the model 316 in FIG. 3 (block 304). The gingival margin is part of the roof of the mouth, which is a static element in the model and does not change position between the first model and the second model. The operator selects the three locations in both the first model and the second model. Each of the triangles forms an orientation triangle for the respective model. As used herein, the term “orientation triangle” refers to a triangle that also defines a geometric plane that can be used to orient two elements or 3D models in a common 3D space. The orientation triangle includes three vertices and a defined center that are used for the identification of common locations between elements in two different models and for identifying vertex normals that enable the rotational orientation of two different 3D models in a 3D space. The processor 108 generates normals to the vertices of the triangles for the first and second models (block 308). As is known in the art, each side of the triangle is characterized as a vector, and the processor 108 identifies a cross-product for the vectors that intersect at each vertex of the triangles. The processor 108 then orients the planes formed by the first and second triangles and the corresponding models using a quaternion rotation process in conjunction with the normals for the first and second triangles (block 310). The quaternion rotation process orients both 3D models to a common plane in a 3D space for superimposition as described below in process 200. The generation of the orientation triangle 312 and corresponding quaternions in FIG. 3 is a “low precision” process that enables interaction with the 3D models but does not require that the vertices of the orientation triangle 312 be placed in precise points of the 3D model 316 to be effective.

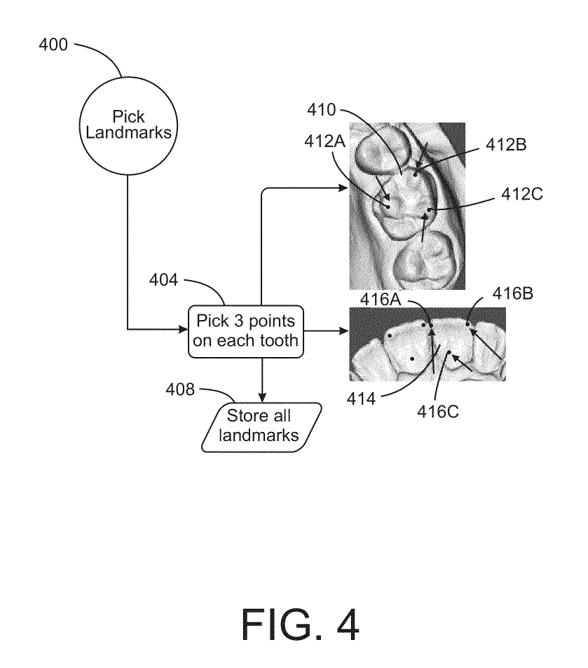

Referring again to FIG. 2, process 200 continues with selection of features or “landmarks” on one or more dynamic elements in the first and second 3D models (block 220). FIG. 4 depicts a landmark selection process 400 that occurs during process 200 in more detail. In FIG. 4, the operator of the computer 104 selects three locations on each of the dynamic elements in the model of the object that are being analyzed for movement between the first and second models (block 404). In the computer 104, an operator selects locations on the surface of one or more teeth, which are dynamic elements in the model of the mouth. The operator views the teeth from different perspectives using the display device 140 and selects three locations on each tooth using the input devices 144. In FIG. 4, the operator uses the input devices to select the locations 412A, 412B, and 412C on a crown of a tooth 410. For another tooth 414, the operator selects locations 416A, 416B, and 416C. While FIG. 4 depicts an avatar graphical model of the teeth 410 and 414, another embodiment depicts point cloud data in a 3D space corresponding to the teeth 410 and 414. The operator selects three locations on the teeth 410 and 414 in both the first 3D model and the second 3D model. The processor 108 stores the landmark data in the RAM 122 or disk 124 for use in identifying movement of the teeth between the first and second models (block 408).

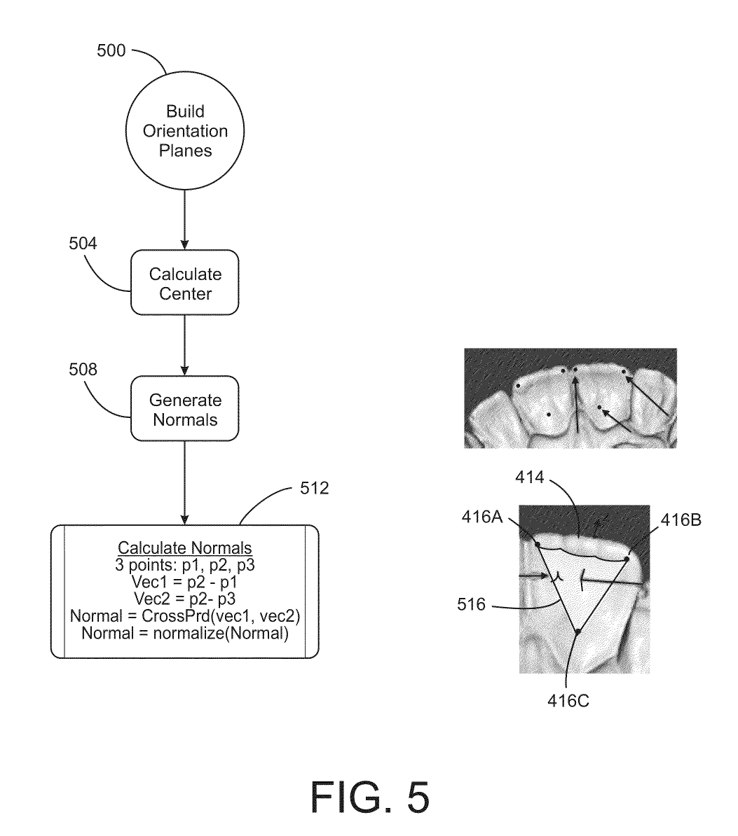

Referring again to FIG. 2, after identification of feature locations on one or more teeth, the process 200 continues as the processor 108 generates orientation triangles for individual dynamic elements in the first and second 3D models of the object (block 224). FIG. 5 depicts an orientation triangle generation process 500 that occurs during the process 200 in more detail. In FIG. 5, the processor 108 identifies a center of a triangle formed between the three feature locations that are selected for each dynamic element (block 504). In FIG. 5, the tooth 414 from FIG. 4 is a dynamic element and the processor 108 identifies the geometric center of the triangle 516 that is formed from the selected feature locations 416A, 416B, and 416C. The processor 108 also generates normals for the vertices of the triangle 516 (block 508). The processor generates the normals using from cross-products of vectors formed from the vertices of the triangle 516 in a similar manner to the generation of normals described above with reference to the generation of normals in FIG. 3 (block 512).

Process 200 continues with optional positioning of avatars for either or both of the static and dynamic elements in the 3D model (block 228). As described above, the avatars are 3D graphical models corresponding to the elements in the object. In a mouth, the avatars include teeth, bones in the palate, the jaw, and any other elements of interest during orthodontic treatment. The avatars include 3D models corresponding to generic models of teeth such as the incisors, canines, bicuspids, and molars. The processor 108 positions the avatars for the teeth using the selected landmark locations that are selected above during the processing described with reference to block 220 and the orientation triangle that is generated during the processing described above with reference to block 224. The positioning of graphical avatars for the teeth and other elements in the 3D models is optional and is not required for the identification of movement of teeth between the first 3D model and the second 3D model.

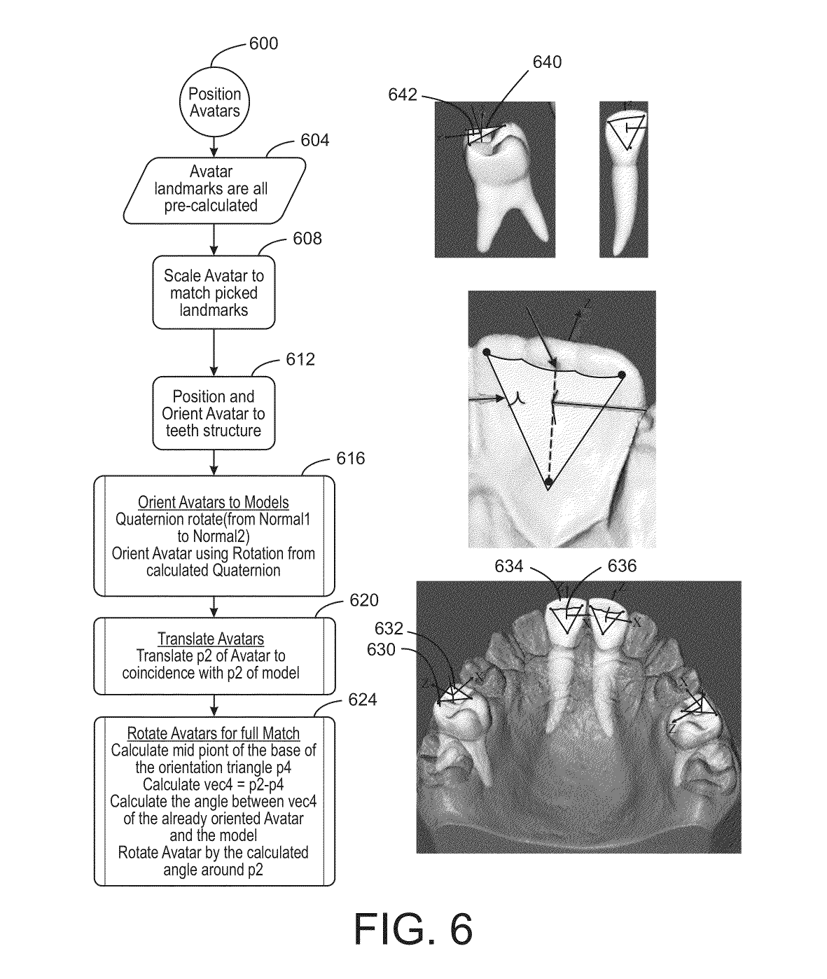

FIG. 6 depicts a process 600 for positioning a graphical avatar for the corresponding element in the 3D model during the process 200. In process 600, the landmarks on the graphical avatar are identified before the process 600 begins, and the computer 104 does not require additional input from the operator to identify landmarks on the avatar graphics models (block 604). For example, the tooth avatar 630 includes a predetermined orientation triangle 632 that is generated for landmarks on the crown of the graphical avatar 630, and the tooth avatar 634 include another orientation triangle 636 that is generated for landmarks on the surface of the graphical avatar 634. The landmarks for the avatars also include surface normals for the orientation triangles that are used to rotate the planes and the corresponding graphical avatars using quaternion rotation. The processor 108 scales the avatar graphical model to correspond to the size of the corresponding tooth in the 3D model for the mouth (block 608). The processor 108 scales the avatar graphical model using 3D graphical scaling techniques that are known to the art. In one embodiment, the processor 108 scales the graphical avatar so that the dimensions of the orientation triangle associated with the graphical avatar are the same dimensions as the orientation triangle that corresponds to the tooth in the 3D model.

During process 600, the processor 108 also positions and orients the graphical avatar to the corresponding tooth in the 3D model (block 612) as described in more detail below. The processor 108 first orients the graphical avatar to the orientation triangle of the full 3D model using the quaternion rotation process for the normals of the graphical avatar and the normals of the orientation triangle of the 3D model (block 616). As describe above with reference to FIG. 3, the orientation triangle for the full 3D model is generated from feature landmarks selected from a static element, such as the palate of the mouth. The processor 108 also translates the location of the graphical avatar to coincide with the location of the tooth in the 3D space including the model (block 620). In one embodiment, the translation includes changing the coordinates of the graphical avatar along three axes in a 3D coordinate system, such as the x, y, and z axes in a Cartesian 3D coordinate system. The translation process moves the identified center of the orientation triangle for the avatar to the same 3D coordinates as the identified center of the orientation triangle for the tooth in the 3D model. For example, the translation process moves the center of the orientation triangle 632 and the corresponding graphical avatar 630 to the coordinates of the center of an orientation triangle 642 for tooth 640 in the 3D model. The translation process does not affect the rotation of the graphical avatar, which are referred to as the pitch, roll, and yaw of the graphical avatar. During process 600, the processor 108 rotates the graphical avatar to align the graphical avatar with the tooth in the 3D model (block 624). The processor 108 performs a quaternion rotation with reference to the identified normals of the graphical avatar and the orientation triangle of the tooth to rotate the graphical avatar into the same orientation as the tooth with the orientation of the graphical avatar being aligned with the orientation triangle of the tooth. The processor 108 rotates the graphical avatar about the center of the orientation triangle for the avatar, which remains in the same translational location during the rotation process. During process 200, the processor 108 optionally positions graphical avatars corresponding to one or more teeth in both the first and second 3D models.

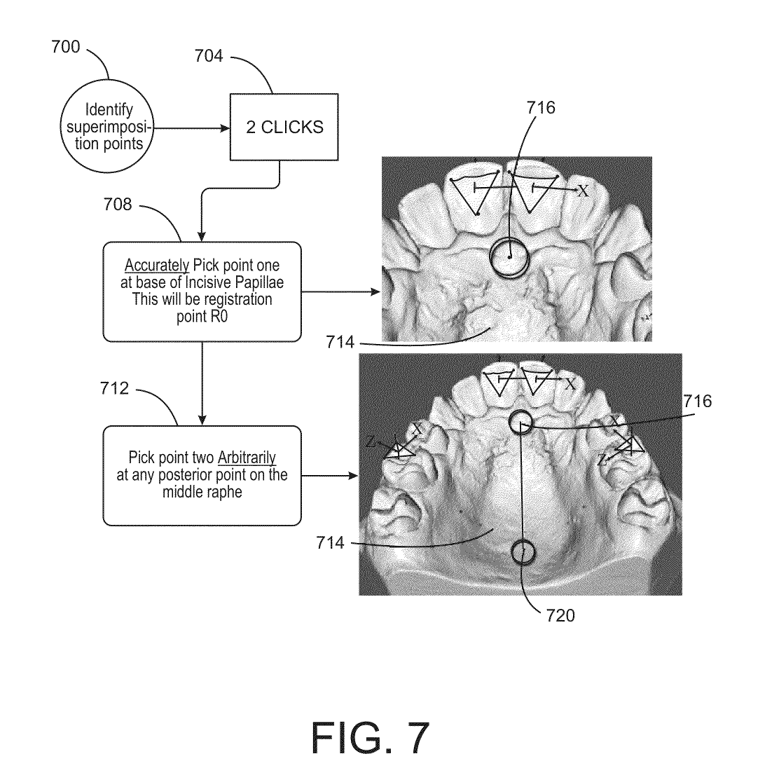

Referring again to FIG. 2, process 200 continues with identification of locations in the first and second 3D models that are used for superimposing the second 3D model on the first 3D model (block 232). The superimposition process aligns at least one static element in the first and second models and enables generation of graphical displays depicting changes in the position of dynamic elements between the first and second 3D models. FIG. 7 depicts a process 700 for identifying superimposition locations during the process 200 in more detail. In the process 700, an operator of the computer 104 identifies two locations in each of the first and second 3D models using a “two clicks” process 704 where the operator identifies two locations on a static element of the 3D model to use as reference locations when superimposing the two 3D models. The operator uses the input devices 144 to select the locations on a visual display of the 3D model that is presented through the display device 140. During process 700, the operator locates one of the features with high precision (block 708). In the example of a mouth, the palate 714 is a static element and the operator identifies and selects the base of the incisive papillae 716 as a precise location in the 3D model. The operator also selects and locates a second reference location on the static element with lower precision (block 712). In the example of FIG. 7, the operator selects a second location 720 within the middle raphe region of the palate 714. During process 700, the operator selects the base of the incisive papillae location 716 with high precision in both the first and second 3D models, but the operator can select a wide range of different locations within the middle raphe region of the palate 714 as the second reference location 720 in the first and second 3D models.

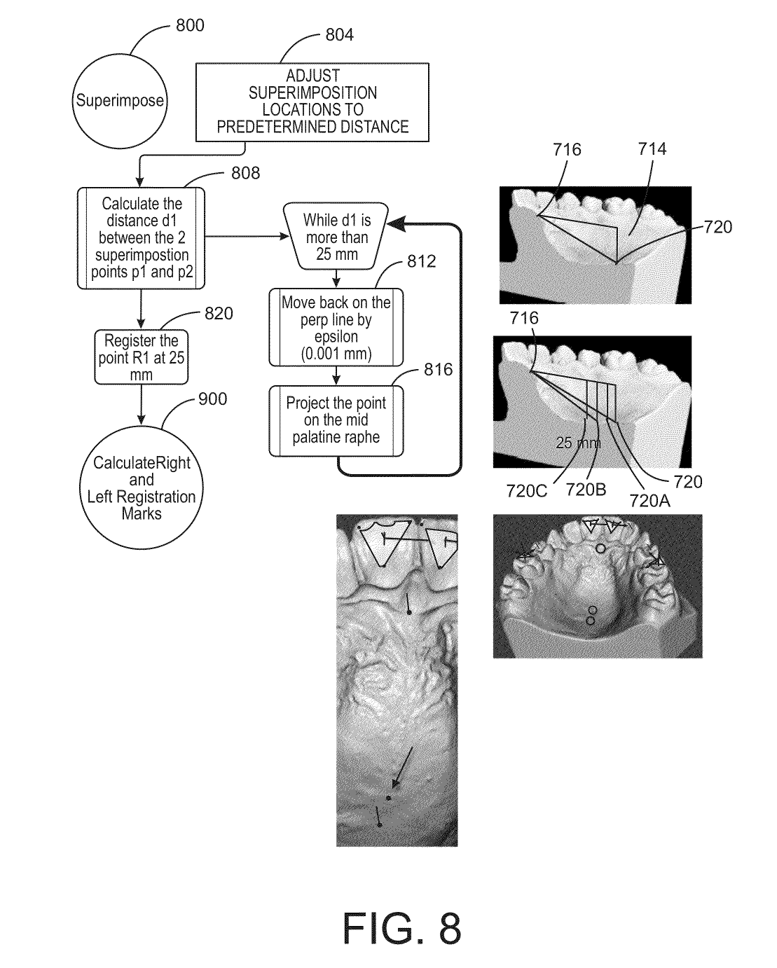

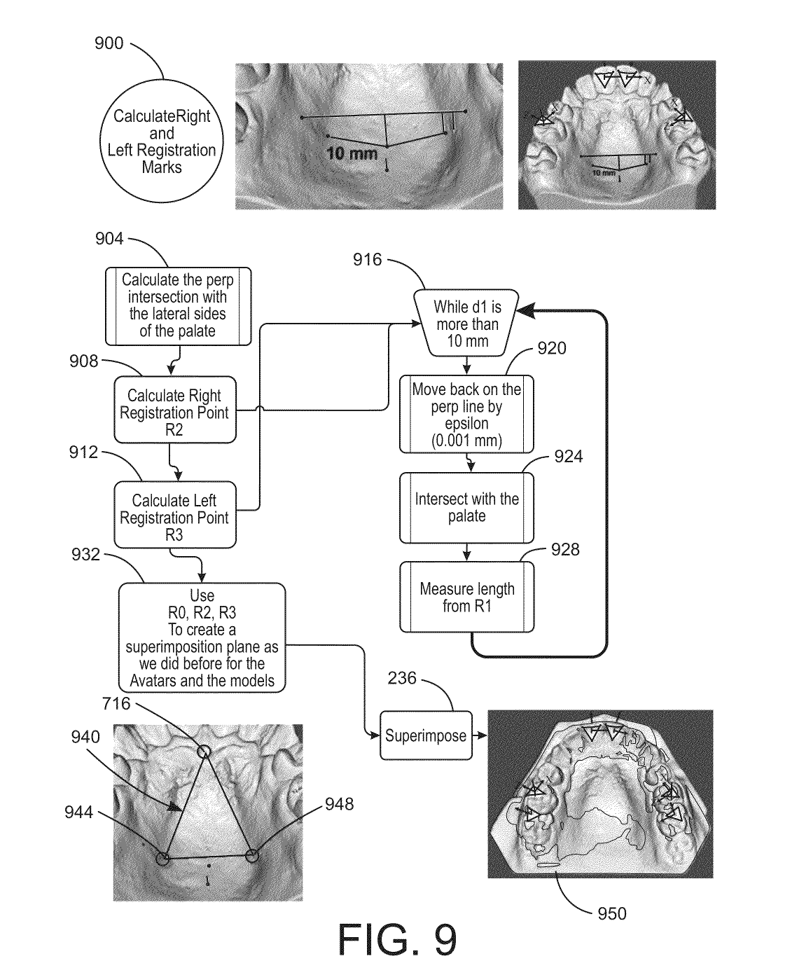

Referring again to FIG. 2, the process 200 continues as the processor 108 superimposes the second 3D model on the first 3D model using the selected reference locations to align the superimposed 3D models (block 236). FIG. 8 and FIG. 9 depict the superimposition process in more detail. In FIG. 8, the superimposition process 800 includes an adjustment of the selected superimposition landmark locations in the 3D model to separate the landmark locations by a predetermined distance, such as 25 mm, in the 3D model (block 804). In the process 800, the processor 108 identifies if the linear distance between the selected superimposition reference locations 716 and 720 exceed the predetermined distance (block 808). The processor 108 iteratively decreases the distance by moving the second reference location 720 toward the first reference location 716 by a predetermined increment in a two-dimensional plane extending parallel to the longitudinal axis of the mouth (block 812). The predetermined increment distance is, for example, 0.001 mm. The processor 108 then projects a new location for the reference location 720 on the raphe of the palate 714 in the 3D model and identifies if the distance between the reference locations 716 and 720 remains beyond 25 mm (block 816). The process 800 continues iteratively as depicted with the reference locations 720A, 720B, and 720C that are generated at increasingly closer distances to the reference location 716 until the distance between the reference locations is less than 25 mm.

Once the processor 108 adjusts the locations of the superimposition locations 716 and 720 to the predetermined distance in both the first 3D model and the second 3D model (block 820), the processor 108 identifies left and right registration locations between the first and second 3D models as depicted in more detail in the registration process 900 of FIG. 9. In the process 900, the processor 108 identifies locations of intersections between a plane that is perpendicular to the lateral sides of the palate in the 3D model (block 904). The processor 108 identifies left-side and right-side registration locations corresponding to the intersection between the plane and the left and right lateral walls of the palate, respectively (blocks 908 and 912). The processor 108 then identifies if the distance between the registration points exceeds a predetermined threshold distance, such as 10 mm (block 916). The processor 108 moves the plane toward the apex of the raphe in the palate (i.e. the top of the roof of the mouth) by a predetermined increment, such as 0.001 mm (block 920). The processor 108 then identifies the intersections between the plane at the adjusted location (block 924) measures the distance between the left and right registration locations (block 928). The processor 108 adjusts the plane in an iterative manner until the distance between the left and right registration locations is less than the predetermined distance (block 916).

Referring to both FIG. 9 and FIG. 2, the processor 108 generates an orientation triangle 940 using the reference location 716 from the process 700 in conjunction with the left registration location 944 and right registration location 948 from the process 900 (block 932). The processor 108 generates the orientation triangle in both the first model and the second model, with the reference location 716 acting as a common location between the two models. The processor 108 then performs the superimposition of the second 3D model on the first 3D model. In the superimposed models, the two triangles that are formed in the first and second models are coplanar with the reference location 716 in both the first and second models occupying the same location in the superimposed model. In one embodiment, the processor 108 scales the second 3D model to correspond to the size of the first 3D model with the orientation triangles in the first and second 3D models being scaled to the same size. The processor 108 also translates the reference location 716 in the second 3D model in a 3D coordinate space to have the same coordinates of the reference location 716 in the first 3D model. Since the first 3D model and the second 3D model are already rotated to a common orientation, as describe above with reference to the processing of blocks 212 and 300, the processor 108 does not have to perform additional rotations to the 3D models to superimpose the second model on the first model. The processor 108 generates a graphical display 950 of the superimposed 3D models that optionally applies different colors, textures, or other distinguishing graphical effects to the first and second 3D models to enable a doctor or other healthcare provider to distinguish between the first and second 3D models in the superimposed graphical display.

Referring again to FIG. 2, process 200 continues as the processor 108 identifies movement of one or more dynamic elements, such as teeth, between the first model and the second model in a three-dimensional space with six degrees of freedom (DOF) (block 240). As used herein, the “movement” of a dynamic element with six degrees of freedom refers to linear translational movement in a 3D coordinate space (i.e. movement on x, y, and z axes) and rotational movement along pitch, roll, and yaw axes that correspond to the translational axes. Thus, a tooth may move along one or more of the x, y, and z three dimensional axes while rotating along one or more of the pitch, roll, and yaw axes between the time when the first 3D model is generated and the later time when the second 3D model is generated.

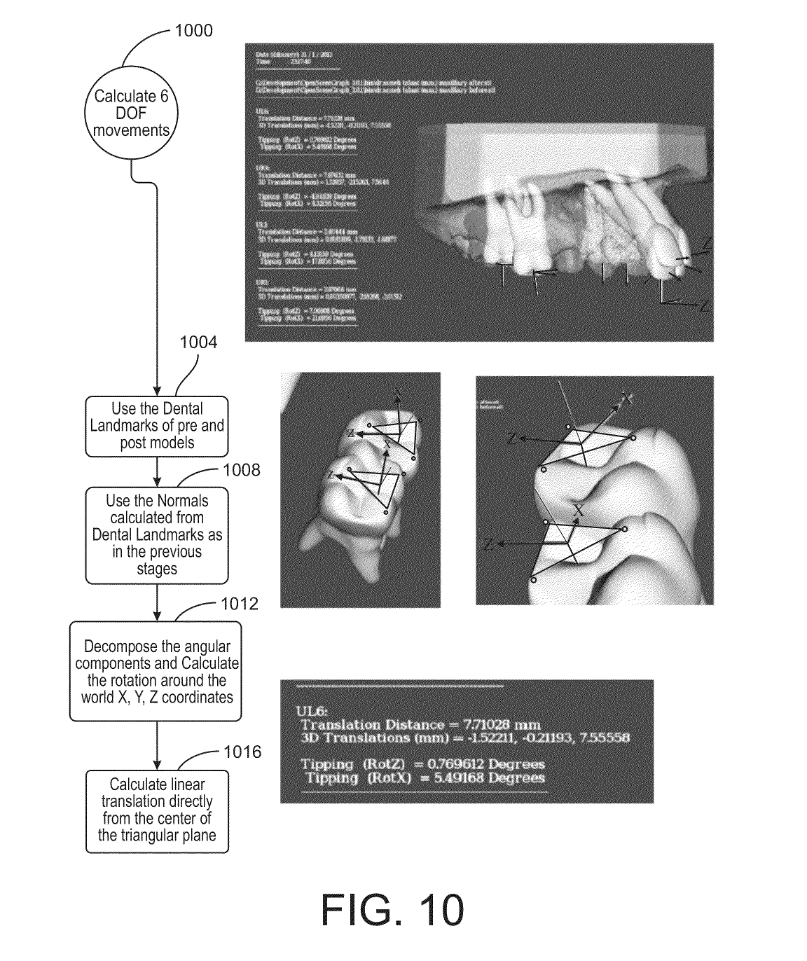

FIG. 10 depicts a process 1000 for measuring the movement of a tooth during the process 200 in more detail. In FIG. 10, the processor 108 identifies the landmarks for the tooth that are selected in both the first 3D model and the second 3D model during the processing described above with reference to block 220 and the process 400 (block 1004). The processor 108 also identifies the normals that are generated for the orientation triangles during the processing described above with reference to block 224 and the process 500 (block 1008). The processor 108 identifies movement of the tooth including both rotation and linear translation of the tooth. For rotation, the processor 108 calculates the 3D angle between the two orientation normals to represent the overall change in orientation, and then decomposes the 3D angle to three rotations around the three coordinate axes to represent the rotation around each individual coordinate axis (block 1012). For the linear translation, the processor 108 identifies the center coordinates for each of the orientation triangles of the tooth in the first and second models after the superposition process. The linear distance between the center of the orientation triangle in the first 3D model and the center of the orientation triangle in the second 3D model corresponds to the linear translation of the tooth (block 1016). As depicted in FIG. 10, the computer 104 can generate graphical outputs depicting the movement of a tooth between the first and second 3D models, and can generate text output including numeric measurements of the rotation and translation of the tooth between the first and second models. The 3D models depicted in FIG. 10 include the optional graphical avatars that are used to generate visual depictions of the teeth, but in an alternative configuration, the graphical output includes the 3D model generated from the first and second sets of scanned point cloud data from the laser scanner 150.

While the embodiments have been illustrated and described in detail in the drawings and foregoing description, the same should be considered as illustrative and not restrictive in character. It is understood that only the preferred embodiments have been presented and that all changes, modifications and further applications that come within the spirit of the invention are desired to be protected.

What is claimed:

1. A method for generating a graphical output depicting three-dimensional models comprising:
generating with a processor a first orientation triangle, the first orientation triangle being generated with reference to a first plurality of locations on a first element in a first three-dimensional (3D) model of an object stored in a memory, the first element occupying a first position in the first 3D model and a second position in a second 3D model of the object stored in the memory;
generating with the processor a second orientation triangle for the first element from a second plurality of locations on the first element in the second 3D model of the object; and
generating with the processor and a display device a graphical display of the oriented second 3D model superimposed on the first 3D model, the graphical display depicting a change in position of the first element between the first 3D model and the second 3D model with reference to the first orientation triangle and the second orientation triangle.

2. The method of claim 1 further comprising:
superimposing with the processor the second 3D model on the first 3D model with reference to a first reference location and a second reference location on a second element of the first 3D object, the second element in the first 3D model remaining in a fixed position between the first 3D model and the second 3D model of the object.

3. The method of claim 2, the superimposition further comprising:
orienting with the processor the first 3D model and the second 3D model with reference to a third plurality of locations on the second element in the first 3D model and a fourth plurality of locations on the second element in the second 3D model.

4. The method of claim 3, the superimposition further comprising:
identifying with the processor a first triangle corresponding to a first plane, the first triangle comprising the first reference location on the second element of the first 3D model, and two locations in the third plurality of locations on the second element of the first 3D model that are arranged to form the first triangle with the first reference location;
identifying with the processor a second triangle corresponding to a second plane, the second triangle comprising the second reference location on the second element of the second 3D model, and two locations in the fourth plurality of locations on the second element of the second 3D model that are arranged to form the second triangle with the second reference location; and
aligning with the processor the first triangle with the first model and the second triangle with the second model to be coplanar to superimpose the first model and the second model.

5. The method of claim 2 wherein the first 3D model and second 3D model of the object correspond to an interior of a mouth, the first element being a tooth and the second element being a roof of the mouth.

6. The method of claim 5 further comprising:
identifying with the processor a rotation of the tooth with reference to a difference in orientation of the first orientation triangle and the second orientation triangle; and
generating with the processor and the display device the graphical display indicating the identified rotation of the tooth.

7. The method of claim 5, the generation of the graphical display further comprising:
retrieving with the processor from the memory a graphical avatar corresponding to the tooth; and
displaying with the processor and the display device the graphical avatar for the tooth in the first position of the first element in the first 3D model; and
displaying with the processor and the display device the graphical avatar for the tooth in the second position of the first element in the second 3D model.

8. A system that generates a graphical output depicting three-dimensional models comprising:
a memory configured to store:
first three-dimensional (3D) model data of an object including a first element and a second element, the first element being in a first position relative to the second element;
second 3D model data of the object including the first element in a second position relative to the second element;
a display device; and
a processor operatively connected to the memory and the display device, the processor being configured to:
generate a first orientation triangle with reference to a first plurality of locations on the first element in the first 3D model;
generate a second orientation triangle with reference to a second plurality of locations on the first element in the second 3D model; and
generate with the display device a graphical display of the second 3D model superimposed on the first 3D model, the graphical display depicting a change in position of the first element between the first 3D model and the second 3D model with reference to the first orientation triangle and the second orientation triangle.

9. The system of claim 8, the processor being further configured to: superimpose the second 3D model on the first 3D model with reference to a first reference location and a second reference location on a second element of the first 3D object, the second element in the first 3D model remaining in a fixed position between the first 3D model and the second 3D model of the object.

10. The system of claim 9, the processor being further configured to:
orient the first 3D model and the second 3D model with reference to a third plurality of locations on the second element in the first 3D model and a fourth plurality of locations on the second element in the second 3D model.

11. The system of claim 10, the processor being further configured to:
identify a first triangle corresponding to a first plane with reference to the first reference location on the second element of the first 3D model, and two locations in the third plurality of locations on the second element of the first 3D model that are arranged to form the first triangle with the first reference location;
identify a second triangle corresponding to a second plane with reference to the second reference location on the second element of the second 3D model, and two locations in the fourth plurality of locations on the second element of the second 3D model that are arranged to form the second triangle with the second reference location; and
align the first triangle with the first model and the second triangle with the second model to be coplanar to superimpose the first model and the second model.

12. The system of claim 9 wherein the first 3D model and second 3D model of the object correspond to an interior of a mouth, the first element being a tooth and the second element being a roof of the mouth.

13. The system of claim 12, the processor being further configured to:
identify a rotation of the tooth with reference to a difference in orientation of the first orientation triangle and the second orientation triangle; and
generate the graphical display indicating the identified rotation of the tooth.

14. The system of claim 12, the processor being further configured to:
retrieve a graphical avatar corresponding to the tooth from the memory; and
display with the display device the graphical avatar for the tooth in the first position of the first element in the first 3D model; and
display with the display device the graphical avatar for the tooth in the second position of the first element in the second 3D model.
